(19) United States
(12) Patent Application Publication
(10) Pub. No.: US 2007/0078663 A1
(43) Pub. Date: Apr. 5, 2007

(54) Method and instrument for proposing marriage to an individual

(76) Inventor: Ryan Thomas Grace, Omaha, NE (US)

Correspondence Address: Merchant & Gould P.C., Suite 4700, 701 Fifth Avenue, Seattle, WA, 98104, US

(21) Appl. No.: 10/378,423

(22) Filed: Mar. 3, 2003

(51) Int. Cl. G06Q 99/00

(52) U.S. Cl. 705/1

(57) ABSTRACT

The purpose of this invention is to provide an improved method of proposing marriage to an individual. The method of proposing to an individual generally comprising the steps of meeting the individual; exchanging names with the individual; dating the individual (not necessary); drafting a government document having a proposal to marry the individual incorporated therein; and showing the government document to the individual. The government document may be a patent application. The patent application may claim the method by which the proposor will make a marriage proposal to the individual. The proposor could then use the method claimed in the patent application to propose to the individual. The patent application could be the actual marriage proposal.

### BACKGROUND OF THE INVENTION

1. Field of the Invention

The present invention relates to a method and instrument for proposing marriage to an individual. More particularly, the present invention relates to a unique method and instrument for proposing to an individual by which the proposor can righteously tout the uniqueness of the proposal.

2. Description of the Related Art

Since the advent of the human race, endearment between two individuals has been expressed through various means. In the situation where a man expresses endearment to a woman, such endearment is sometimes conveyed through different avenues as the relationship progresses. As is custom in several cultures, once a relationship between two individuals progresses to a certain point, one of the individuals (a proposor) must propose marriage to the other individual in order to advance the relationship. The anticipation of proposing can impress a high level of pressure on the proposor to propose in a manner that will receive an affirmative response from the individual. As this custom progressed, the high level of pressure from the situation has sometimes forced the proposor into implementing non-traditional methods of proposal in order to woo the individual into an affirmative response.

One method for proposing marriage to an individual can be referred to as the diamond in champagne method. To instigate this method, the proposor will first invite the individual on a romantic date. Usually, such a date takes places in an upscale restaurant and the proposor orders champagne. When the individual's back is turned or when the individual goes to the restroom, the proposor slips a diamond ring into the individual's glass of champagne. In the situation where the individual acknowledges the ring before swallowing and choking on the ring, the proposor will then get down on one knee and propose marriage to the individual.

Another method for proposing marriage to an individual may be referred to as the “message in the sky” method. This method is sometimes implemented when both the proposor and the individual are avid sports fans. To instigate this method, the proposor will arrange to have a banner with a proposal thereon flown over a sports stadium where the proposor and the individual are watching a sporting event. At just the right moment, the proposor will tell the individual to look up as the banner is flown overhead. After the individual sees the banner, the proposor will reveal a diamond ring and give the ring to the individual.

Still another method of proposing marriage to an individual may be referred to as the “monument proposal.” This method usually takes place at a significant landmark or monument. Some significant landmarks where an individual might propose are the Eiffel Tower, the Leaning Tower of Pisa, the Empire State Building, or Willie's Bar in Valley, Nebr. The proposor will usually wait to propose until the proposor and the individual have reached an intimate, romantic area of the landmark. At just the right moment, the proposor will get down on one knee and reveal a diamond.

As the industrial revolution has passed and the computer revolution has taken afoot, society has been submerged with innovation and novel ideas. With the regularity of such innovation, society has become more prone to demand novel ideas and innovative thinkers. This bias toward innovation has raised the bar not only for industries, computers, and manufacturing, but also for individuals involved in relationships. Individuals want their relationship to be as unique and novel as the ideas that sparked the industrial and computer revolution. Furthermore, individuals in a relationship demand such uniqueness in their marriage proposal so that the individual can tout such uniqueness and novelty in the relationship and have a written record of such events. A significant setback to the aforementioned methods of proposing to marry an individual is that they lack novelty and innovative effort. Such a lack of novelty and innovative effort in a method of proposing to an individual may result in a negative response from the individual in an effort to wait for a more memorable moment.

Accordingly, a need exists for a unique, novel, and recorded method of proposing marriage to an individual.

### SUMMARY OF THE INVENTION

In this invention an improved method for a proposor to propose to an individual is disclosed. The method of the present invention generally comprises the steps of meeting an individual; exchanging names with the individual; drafting a government document having a proposal to marry the individual incorporated therein; and showing the government document to the individual.

The meeting step set forth above may further comprise the proposor meeting the individual in a tavern while the individual is emotionally connected to a current boyfriend. The meeting step preferably includes the proposor meeting the individual for a second time when the emotional connection between the individual and the current boyfriend is at least partially severed. The meeting step might also include the proposor having a suave disposition and conveying wooing words to the individual. The proposor might also believe that such wooing words and suave disposition instigated the complete severing of the emotional connection between the individual and the current boyfriend.

Even though not necessary to the method of the present invention, the method might include a dating step having at least one substantially unromantic first date at a bar where the individual works. The substantially unromantic first date could also include the individual inviting a friend from Chicago, Ill., on the unromantic first date. Along with the first date, the dating step might include a plurality of dates. One such date might include a trip to Savannah, Ga. Other such dates could include a trip from Omaha, Nebr., to Kansas City, Mo., or a trip from Omaha, Nebr., to Nassau in the Bahamas. In the event that the proposor and the individual desire to remain in Omaha, Nebr., on one of the plurality of dates, the proposor, preferably, asks the individual on such a date at least one week in advance. The proposor might also open the door of a vehicle for the individual or give the individual flowers while on such a date.

The step of drafting a government document having a marriage proposal disclosed therein might also include the government document being a patent application. The patent application may then disclose a method by which a marriage proposal occurs. The proposor could then implement the claimed method and propose to the individual. The proposor might also be starting a third year of law school and studying for the examination to practice before the United States Patent and Trademark Office while drafting the patent application.

After drafting the government document, the government document is shown to the individual as generally defined by the showing step. The showing step may comprise placing the government document in a limousine where the individual can find the government document. The proposor could then arrange to have the limousine meet the proposor at a predetermined location where the proposor presents a diamond ring to the individual. The proposor then signs and deposits the patent application with the United States Postal Service.

One of the principal objects of the invention is to provide a method by which a proposor's clever proposal coaxes an individual into marrying the proposor.

Yet another object of the invention is to provide an entirely unique method for a proposor to propose marriage to an individual.

Still another object of the invention is to provide a method for proposing marriage to an individual where the proposor can righteously tout the uniqueness of the proposal.

Yet another object of the invention is to provide a method of proposing marriage to an individual where the method of proposing is at least partially related to the proposor's future profession.

Still another object of the invention is to provide a method of proposing to an individual where the method is recorded in a government document for all the world to see.

These and other objects will be obvious to those skilled in the art.

### BRIEF DESCRIPTION OF THE DRAWINGS

FIG. 1 is a flow diagram of the present invention.

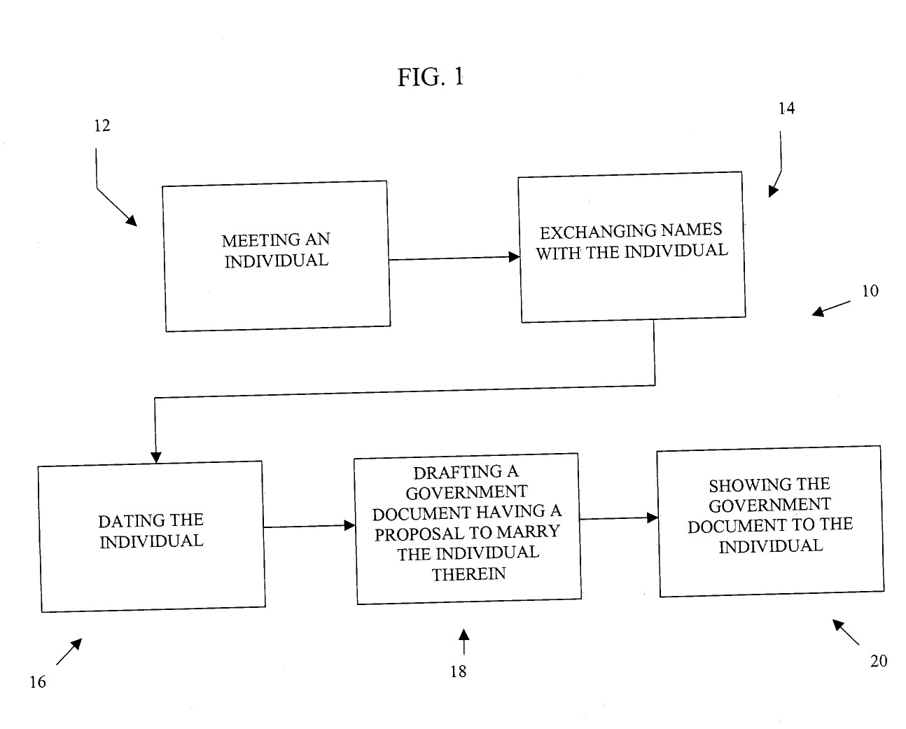

### DESCRIPTION OF THE PREFERRED EMBODIMENT

In the drawings, the method for a proposor to propose to an individual is generally referred to by the reference numeral 10. Method 10 generally comprises the steps of meeting an individual; exchanging names with the individual; drafting a government document having a proposal to marry the individual incorporated therein; and showing the government document to the individual. Preferably, the government document is a patent application. The patent application may claim the method by which the proposor will make a marriage proposal to the individual. The proposor could then use the method claimed in the patent application to propose to the individual. Furthermore, the individual is preferably named Ellen Renee Colyer (hereinafter “Ellie”) and the proposor is preferably named Ryan Thomas Grace (hereinafter “Ryan”). Ryan is more fully described as set forth hereinbelow. Ellie generally comprises a kind, loving individual who has not only been a large support for Ryan during many pressing times, but has also been a large influence on how Ryan approaches life (more so than Ellie will ever let herself realize).

Reference numeral 12 generally refers to the first step of meeting an individual. Preferably, the meeting step 12 further comprises meeting the individual in a tavern located in the Old Market District of Omaha, Nebr. The tavern might also be named the Varsity before it had to close for financial reasons. The individual is preferably positioned adjacent the first floor of the tavern juxtaposed a table and playing electronic trivia. Preferably, the electronic trivia is in electrical communication with a television. The individual may also be emotionally connected to a current boyfriend at the time of the meeting step 12. Where the individual is emotionally connected to a current boyfriend, the inherent problems with such an emotional relationship between the individual and the current boyfriend may be overcome as set forth below. The meeting step 12 may also comprise one or more sub-steps, such as having the individual continuously beat the proposor at electronic trivia in a merciless fashion. However, this step is not necessary and may promote excessive gloating if the proposor concedes defeat. It is contemplated that the reason the individual continuously beats the proposor at electronic trivia in step 12 is because the proposor allows the individual to win. However, such a concession, if openly expressed improperly, could be substantially detrimental to the progression of the method of proposing 10.

The meeting step 12 may also involve meeting the individual a second time when the emotional connection to the current boyfriend is at least partially severed. Meeting step 12 could also include the proposor having a suave disposition and conveying wooing words to the individual in order to instigate the complete separation of the individual's emotional connection to the current boyfriend. Although not imperative, meeting step 12 could also include the proposor believing that the wooing words and suave disposition instigated the complete emotional separation of the individual and the current boyfriend. However, it is preferred that this belief is not conveyed to the individual during the meeting step 12. Only after the dating step 16 is complete may the proposor make such boastful claims; yet, even then, the proposor should be prepared to sustain strong opposition from the individual for such statements. Meeting step 12 may further include the proposor lying on a first couch while conveying the wooing words to the individual in a Casanova manner and the individual lying on a second couch while receiving the wooing words. It is also contemplated that the Casanova behavior might have absolutely no effect on the individual. In such situations, it might be imperative for the proposor to make up excuses for the individual's lack of interest so as to not damage the proposor's ego. However, skillful artisans will not have this problem.

Furthermore, meeting step 12 may also include the proposor forgetting to ask the individual for a telephone number to contact the individual and the telephone number not being in a telephone book. However, this step is not imperative and depending on the particular chemical and behavioral composition of the individual, this step could sever the method 10 before the dating step 16 begins. In the situation where the proposor forgets to ask the individual for a telephone number, the proposor may need to contact an acquaintance and ask the acquaintance for the telephone number of the individual. In the situation where the acquaintance refuses to convey the telephone number of the individual, meeting step 12 becomes more complicated. However, it is preferred that the proposor use any persuasive technique or form of bribery so that the acquaintance conveys the telephone number of the individual to the proposor.

During the meeting step 12 or at a time closely thereafter, the exchanging names step 14 occurs. The exchanging names step 14 may further include the sub-step of having incorrect knowledge of the individual's name. For example, this could occur where the individual's name is “Ellie” and the proposor believes that the name of the individual is “Ali.” This might occur where the proposor was never told that “Ellie” and “Ali” are pronounced differently so that for a substantial period of time the proposor pronounces the name of the individual as “Ali.” This step should be practiced with extreme caution and if possible, the proposor should never knowingly forfeit information on the proposor's incorrect knowledge of the individual's name. Generally, only the most skilled artesian should practice the exchanging names step 14 in the aforementioned manner. Where the proposor has incorrect knowledge of the individual's name for prolonged periods of time, the dating step 16 might never take place. Where the proposor has incorrect knowledge of the individual's name for less than one month, the dating step 16 may continue after the individual is emotionally upset for approximately one week and the individual is showered with gifts. However, the outcome of this step is partially dependent on the chemical and behavioral composition of the individual and should be practiced with extreme caution.

In order for the method of the present invention to progress, a dating step 16 might also take place. The dating step 16 is not necessary because some of the most crafty and skillful artisans may be able to skip the dating step and propose to an individual after the exchanging names step 14. However, such situations are rare and most proposors will have at least one date with an individual. Some proposers may need to be in the dating step 16 for nearly five years. This is not to say that such a proposor is not an extremely crafty and skillful artisan. The reason for such a long dating step 16 might include the proposor trying to think of a unique method of proposing marriage to the individual. Such a proposor might be attempting to get the method of proposing to the individual patented and the method by which the proposal takes place being the very method described in the patent application. Yet, such aspirations of the proposor might not be relevant to the individual so it is suggested that the proposor not take five years to propose. When such a proposal takes five years or more, the individual might threaten to find a more skillful artisan.

The dating step 16 may include at least one unromantic first date. The first date may involve having the individual invite a friend from Chicago on the first date. The first date could take place at a bar where the individual is employed. In the situation where the friend from Chicago attends the first date, it is preferred that the first date takes place on the patio of the bar and several beverages are orally consumed to alleviate first date jitters. In the ideal situation, the friend from Chicago approves of the dating step 16; however, it is not believed that the approval of dating step 16 is crucial to successfully complete dating step 16. The friend's approval of dating step 16 is merely a means to expedite the early stages of dating step 16.

Along with a first date, the dating step 16 may include a plurality of dates. One such date might include taking a trip from Omaha, Nebr., to Savannah, Ga., for a one-week vacation. The vacation could be prompted by several events. One such event may comprise the proposor reading the book Midnight in the Garden of Good and Evil and wanting to visit the historical district of Savannah, Ga. The proposor's infatuation with the aforementioned book might prompt the individual to suggest a one-week vacation to Savannah, Ga. It is recommended that this trip occur at least two months after the meeting step 12.

Such a vacation to Savannah, Ga., may further comprise the proposor driving the individual's uncomfortable black convertible. Preferably, the individual's uncomfortable black convertible is capable of at least one hundred miles per hour. The proposor may desire driving the individual's uncomfortable black convertible at a rate greater than one hundred miles per hour in a manner generally defined in the movie Cannonball Run. However, such high speeds, if sustained for a prolonged period of time, may be detrimental to the health of the proposor and the individual. Such high speeds may also increase the rate of monetary decline in the proposor's pocketbook where the pocketbook is involuntarily connected to several traffic tickets.

Upon arrival in Savannah, Ga., it is recommended that the proposor and the individual lodge at the River Street Inn. The River Street Inn is located juxtaposed a river, a dock, and several shops and taverns. A river view room is recommended if the individual desires such a room; however, such a room is not necessary and might further increase the rate of monetary decline in the proposor's pocketbook. The location of the hotel juxtaposed several shops and taverns is at least partially important where the individual is an enthusiastic shopper and desires to enter the several shops. The shops are generally for the individual's pleasure and the individual may use the taverns to entice the proposor to accompany the individual into the various shops.

In general, the individual's level of shopping enthusiasm is at least partially proportional to the number of pairs of shoes the individual owns. Where the individual owns well over one hundred and twenty pairs of shoes, the individual's level of shopping enthusiasm is considered high and the proximity of the hotel to the shops is very important. Upon familiarity with the individual, the range of shopping enthusiasm will be evident to those skilled in the art.

After entering several of the shops in Savannah, Ga., the individual and the proposor may desire touring several of the cemeteries and historical homes in the area. Preferably, the proposor and the individual tour the cemetery where at least part of the book Midnight in the Garden of Good and Evil was staged. The historical homes may be located along the several park areas of Savannah, Ga., so that the proposor and the individual can walk to the various historical homes of the area. These tours are not imperative to the dating step 16 and are at least partially dependent on the desires of the proposor and the individual.

Along with the aforementioned vacation to Savannah, Ga., the dating step 16 could also include a vacation from Omaha, Nebr., to Kansas City, Mo., and a vacation from Omaha, Nebr., to Nassau in the Bahamas. Preferably, the vacation from Omaha, Nebr., to Kansas City, Mo., includes surprising the individual for the individual's birthday and driving the individual to Kansas City, Mo., for the weekend. Again, for the same reasons set forth above, the proximity of the hotel to the Plaza area of Kansas City is important inasmuch as the Plaza is generally comprised of several shops. With regard to the trip from Omaha, Nebr., to Nassau in the Bahamas, it is preferred that the trip is taken after the proposor's first year in law school and after publication of the proposor's law review article. It is also preferred that the trip is taken right after the individual finishes an undergraduate degree and right before the individual commences nursing school. In some instances, it might also be important for the individual to be previously working long hours on the weekend so that the individual and the proposor rarely see each other. Along with such time-consuming obligations, the individual might also shoulder much of the proposor's complaining, griping, and frustration from law school, law review, clerking for Thomte, Mazour & Niebergall, and the patent bar, making a trip for the individual long overdue. The timing of the trip is partially important because stress levels between the proposor and the individual are at a minimum and conversation between the proposor and the individual will not be confined to the regular ten-minute telephone conversation at twelve o'clock at night.

When the proposor and the individual desire staying in Omaha, Nebr., for one of the plurality of dates of dating step 16, it is recommended that the proposor ask the individual at least one week in advance on such a date. Giving the individual flowers and opening the door of a vehicle in which the individual is entering is also highly recommended in the early stages of dating step 16. Such actions may increase the probability that the dating step 16 will progress. However, if the frequency of giving the individual flowers and opening the vehicle door for the individual decreases as the dating step 16 progresses, opposition from the individual to such a decrease in frequency is highly probable. Accordingly, it is preferred that the proposor's frequency of giving the individual flowers and opening the vehicle door for the individual does not decrease as the dating step 16 progresses. This complexity of dating step 16 may also be referred to as the “milk shake complexity,” i.e., where the proposor sporadically surprises the individual with milk shakes, the individual desires such sporadic milkshake surprises to continue indefinitely.

At some point during the progression of the dating step 16, the proposor may decide to either abandon the dating step 16 or propose marriage to the individual. Where the decision is made to propose marriage to the individual, the proposor drafts the marriage proposal into a government document as generally defined by drafting step 18. Preferably, the government document is a patent application. Where the government document is a patent application, the patent application may have the marriage proposal disclosed and claimed therein. The patent application may also disclose and claim the method by which a marriage proposal could occur. Such a method disclosed and claimed in the patent application might also be the very method by which the marriage proposal did occur. The patent application could be the actual marriage proposal.

In the situation where the government document is a patent application, the drafting step 18 may involve having the proposor be previously educated as a civil engineer and starting a third year of law school at the time step 18 is commenced. The proposor might also have a strong interest in becoming a patent attorney. In the situation where the proposor wants to become a patent attorney, it is preferable that the proposor studies for the examination to practice before the United States Patent and Trademark Office. However, studying for the aforementioned examination while drafting the patent application is not imperative. In some situations, studying for the aforementioned examination while attempting to write a patent application and study for law school might be overly burdensome for the proposor.

One method of studying for the aforementioned examination is through the “Practicing Law Institute Patent Bar Review Course” taught by John White in Los Angeles, Calif. Such a method for studying for the aforementioned examination may be intense and time-consuming for the proposor. Short breaks from studying for the aforementioned examination may be required for the proposor to remain sane. In the event that short breaks are taken, it is preferred that the proposor reminisce about the patience and understanding the individual maintained during the proposor's engineering and law school career. While taking short breaks from studying, the proposor might also draft claims describing the method by which the proposor will propose to marry the individual.

After drafting the government document, the government document is shown to the individual as generally defined by the showing step 20. As stated above, the government document is preferably a patent application. In the preferred embodiment, the showing step 20 might further include hiring a limousine driver to arrive at a predetermined location with a copy of the patent application being positioned on one of the seats of the limousine. It is preferred that the patent application be disposed within a first envelope with the words “open me first” printed thereon.

The proposor may also place a second envelope in the limousine with the words “open me second” printed thereon. In the event that the proposor places a second envelope in the limousine, two round trip tickets to Savannah, Ga., may be enclosed therein. In the event that the individual has given a trip to Las Vegas, Nev., to the proposor for a birthday not knowing that the proposor has been planning a trip to Savannah, Ga., it might be necessary to also include two tickets to Las Vegas in the second envelope. It might also be necessary to make the individual believe that the individual and the proposor are only taking a one-week trip to Las Vegas when in actuality the trip comprises several days in both Savannah and Las Vegas.

After the individual is shown the government document, it might be necessary for the proposor to later interpret the government document for the individual. This might be necessary where the individual does not understand the significance of the document or the rights conferred therefrom. This might also be necessary where the sentimental nature of the document overshadows the significance of the legal rights conferred by the document. In many situations, this step might not be necessary, especially where the individual is familiar with such documents because the proposor complains, grips, whines, and whimpers about such documents on a daily basis.

As previously stated, the government document is preferably a patent application. Where the government document is a patent application, the name of the proposor is preferably Ryan and the name of the individual is preferably Ellie. At least one claim of the patent application may read as follows:
“Ellie I've been in love with you for the last five years. I've known this since the day we met and the time we've spent together since that day has only made me realize this fact more. You have been by my side in every way a person could possibly hope and I would like nothing more than to spend the rest of my life with you. Will you please marry me?”

Furthermore, at least one claim of the patent application may specifically recite “Ellie, if you will marry me, after reading the remainder of this patent application, open the second envelope and tell the limousine driver to take you to the airport.” In the best mode of this invention, Ellie tells the limousine driver to drive to the airport. Ryan should conceal a diamond ring in one of his pockets while waiting at the airport for Ellie. Upon Ellie's arrival, Ryan should present Ellie with the diamond ring.

In the ideal situation where Ellie accepts the diamond ring, Ryan should sign the patent application and deposit the patent application with the United States Postal Service. Preferably, the United States Patent and Trademark Office receives the patent application and, upon examination, issues a patent on the same.

In the drawings and in the specification, there has been set forth preferred embodiments of the invention and although specific items and methods are employed, these are used in a generic and descriptive sense only and not for purposes of limitation. Changes in the form, timing and manner of events, as well as a substitution of equivalents, are contemplated as circumstances may suggest or render expedient without departing from the spirit or scope of the invention as further defined in the following claims. Furthermore, nothing in the aforementioned description of preferred embodiment is to be interpreted as an admission by the applicant of prior art.

Thus, it can be seen that the invention accomplishes at least all of its stated objectives.

1. A method for offering marriage to an individual by converting a patent application into an offer to marry an individual, comprising the steps of:
drafting a patent application to disclose an invention, wherein the patent application is drafted in a tangible medium;
drafting a marriage proposal that proposes marriage to the individual, wherein the marriage proposal is drafted in a tangible medium; and
incorporating the marriage proposal into the patent application, wherein the patent application is converted into an offer to marry the individual for offering marriage to the individual during a proposal event.

2-17. (canceled)

18. The method of claim 1 wherein the offer to marry describes a method of proposing to the individual.

19. The method of claim 18 wherein the offer to marry describes a method of proposing to the individual, wherein the method is the method used to propose to the individual.

20-24. (canceled)

25. The method of claim 1 wherein at least one claim of the offer to marry recites:
“Ellie I've been in love with you for the last five years. I've known this since the day we met and the time we've spent together since that day has only made me realize this fact more. You have been by my side in every way a person could possibly hope and I would like nothing more than to spend the rest of my life with you. Will you please marry me?”

26. The method of claim 25, wherein at least one claim of the offer to marry recites “Ellie if you will marry me, after reading the remainder of this patent application, open the other envelope and tell the limousine driver to take you to the airport.”

27-28. (canceled)

29. The method of claim 1 further comprising sending the offer to marry to the United States Patent and Trademark Office.

30-31. (canceled)

32. A method for offering marriage to an individual by utilizing a patent application to offer marriage to the individual, the method comprising:
drafting a patent application, wherein the patent application is drafted in a tangible medium;
drafting a marriage proposal that proposes marriage to the individual, wherein the marriage proposal is drafted in a tangible medium;
incorporating the marriage proposal into the patent application, wherein the patent application is converted into an offer to marry the individual;
presenting the offer to marry to the individual during a proposal event;
signing the offer to marry the individual; and
sending the offer to marry the individual to the United States Patent and Trademark Office.

33. The method of claim 32 wherein the offer to marry describes a method of proposing to the individual.

34. The method of claim 32 wherein the offer to marry describes a method of proposing to the individual, wherein the method is the method used to propose to the individual.

35. The method of claim 32 wherein at least one claim of the offer to marry recites:
“Ellie I've been in love with you for the last five years. I've known this since the day we met and the time we've spent together since that day has only made me realize this fact more. You have been by my side in every way a person could possibly hope and I would like nothing more than to spend the rest of my life with you. Will you please marry me?”

36. The method of claim 32, wherein at least one claim of the offer to marry recites “Ellie if you will marry me, after reading the remainder of this patent application, open the other envelope and tell the limousine driver to take you to the airport.”

37. A method for offering marriage to an individual by utilizing a patent application to offer marriage to the individual, the method comprising:
drafting a patent application, wherein the patent application is drafted in a tangible medium;
drafting a marriage proposal that proposes marriage to the individual, wherein the marriage proposal is drafted in a tangible medium;
incorporating the marriage proposal into the patent application;
presenting the patent application to the individual during a proposal event;
signing the patent application; and
sending the patent application to the United States Patent and Trademark Office.

38. The method of claim 37 wherein the patent application describes a method of proposing to the individual.

39. The method of claim 37 wherein the patent application describes a method of proposing to the individual, wherein the method is the method used to propose to the individual.

40. The method of claim 37 wherein at least one claim of the patent application recites:
“Ellie I've been in love with you for the last five years. I've known this since the day we met and the time we've spent together since that day has only made me realize this fact more. You have been by my side in every way a person could possibly hope and I would like nothing more than to spend the rest of my life with you. Will you please marry me?”

41. The method of claim 37, wherein at least one claim of the patent application recites “Ellie if you will marry me, after reading the remainder of this patent application, open the other envelope and tell the limousine driver to take you to the airport.”
